(19) United States
(12) Patent Application Publication
(10) Pub. No.: US 2018/0281847 A1
(43) Pub. Date: Oct. 4, 2018

(54) AUTOPILOT ENABLING DEVICE

(71) Applicant: Carl Joseph Reese, Valencia, CA (US)

(72) Inventor: Carl Joseph Reese, Valencia, CA (US)

(21) Appl. No.: 15/937,297

(22) Filed: Mar. 27, 2018

Related U.S. Application Data
(60) Provisional application No. 62/481,012, filed on Apr. 3, 2017.

(51) Int. Cl. B62D 6/00; F16B 1/00

(52) U.S. Cl. CPC B62D 6/00; F16B 2001/0035; B60Y 2400/83; F16B 1/00

(57) ABSTRACT

An autopilot enabling device may be configured to be coupled to portions of a steering wheel of a vehicle. In some embodiments, the device may include an alpha subunit and a beta subunit. The alpha subunit may include a first end, a second end, and an alpha contact surface. The beta subunit may include a first end, a second end, and a beta contact surface. A first coupling may be configured to couple the first end of the alpha subunit to the first end of the beta subunit. The device may be secured to the steering wheel by placing the alpha contact surface in contact with a first portion of the steering wheel, by placing the beta contact surface in contact with a second portion of the steering wheel, and by coupling the first end of the alpha subunit to the first end of the beta subunit.

### CROSS REFERENCE TO RELATED APPLICATIONS

This application claims priority to and the benefit of the filing date of U.S. Provisional Application No. 62/481,012, filed on Apr. 3, 2017, entitled “Autopilot Buddy”, which is hereby incorporated by reference in its entirety.

### FIELD OF THE INVENTION

This patent specification relates to the field of devices configured to interact with the steering systems of vehicles having an autopilot or autosteer function. More specifically, this patent specification relates to a device which is configured to increase the duration that an autopilot or autosteer function may operate.

### BACKGROUND

Many available vehicles are able to be equipped with software and hardware which enables the vehicles to maintain a generally course and speed which is commonly referred to as an autopilot or autosteer feature. These vehicles may be referred to as being autonomous or semi-autonomous. However, most manufactures of these vehicles limit the duration or length of time that the autopilot or autosteer feature may be engaged by requiring the user of the vehicle to interact with the steering wheel at least once during a pre-set time interval. Many users of these vehicles find that these pre-set time intervals are unreasonably short and inconvenient during closed circuit or track driving scenarios.

Therefore, a need exists for novel devices which are configured to increase the duration that an autopilot or autosteer function may operate and which are easily installed and removed onto the steering wheel. A further need exists for novel devices which prevent the autopilot feature in semi-autonomous vehicles from automatically disengaging or from automatically being turned off. There is also a need for novel devices for prevent the vehicle's owner from having to manually reset the autopilot feature in order to prevent being locked out by the vehicle's software or hardware.

### BRIEF SUMMARY OF THE INVENTION

An autopilot enabling device is provided. Preferably, the device may be configured to be coupled to portions of a steering wheel of a vehicle, such as a car, truck, van, bus, boat, or airplane. In some embodiments, the device may include an alpha subunit and a beta subunit. The alpha subunit may include a first end, a second end, and an alpha contact surface. The beta subunit may include a first end, a second end, and a beta contact surface. A first coupling may be configured to couple the first end of the alpha subunit to the first end of the beta subunit. The device may be secured to the steering wheel by placing the alpha contact surface in contact with a first portion of the steering wheel, by placing the beta contact surface in contact with a second portion of the steering wheel, and by coupling the first end of the alpha subunit to the first end of the beta subunit. The weight of the device on the steering wheel may be interpreted as user interaction by the autopilot or autosteer feature of the vehicle thereby preventing the autopilot or autosteer feature the vehicle from automatically disengaging or from automatically being turned off.

In further embodiments, the device may include a second movable coupling which may be configured to couple the second end of the alpha subunit to the second end of the beta subunit. The device may be secured to the steering wheel by placing the alpha contact surface in contact with a first portion of the steering wheel, by placing the beta contact surface in contact with a second portion of the steering wheel, by coupling the first end of the alpha subunit to the first end of the beta subunit, and by and by coupling the second end of the alpha subunit to the second end of the beta subunit.

In still further embodiments, the device may include a wheel aperture which may be formed between the alpha subunit and beta subunit when the first end of the alpha subunit is coupled to the first end of the beta subunit and when the second end of the alpha subunit is coupled to the second end of the beta subunit.

In still further embodiments, the alpha contact surface and beta contact surface may each form at least a portion of the wheel aperture.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a first side perspective view of an example of an autopilot enabling device according to various embodiments described herein.

FIG. 2 illustrates a second side perspective view of an example of an autopilot enabling device according to various embodiments described herein.

FIG. 3 shows a front elevation view of an example of an autopilot enabling device according to various embodiments described herein.

FIG. 4 depicts a side perspective view of an example of an alpha subunit of an autopilot enabling device according to various embodiments described herein.

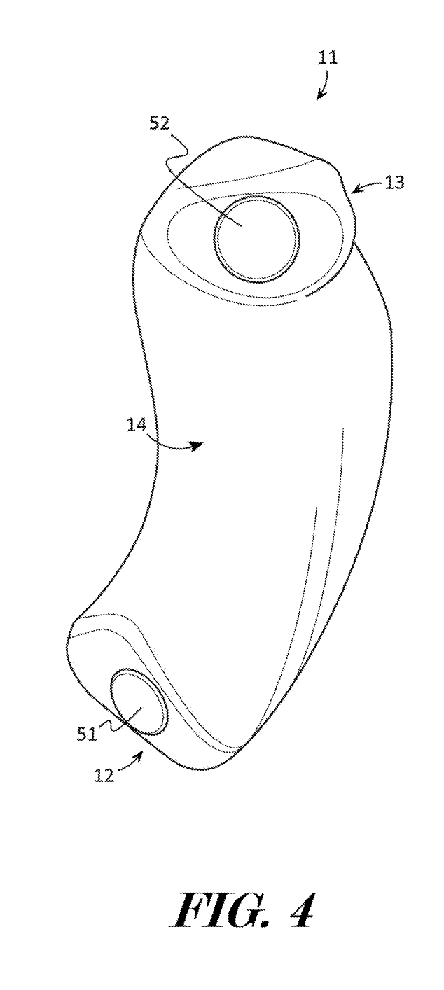

FIG. 5 illustrates a side perspective view of an example of a beta subunit of an autopilot enabling device according to various embodiments described herein.

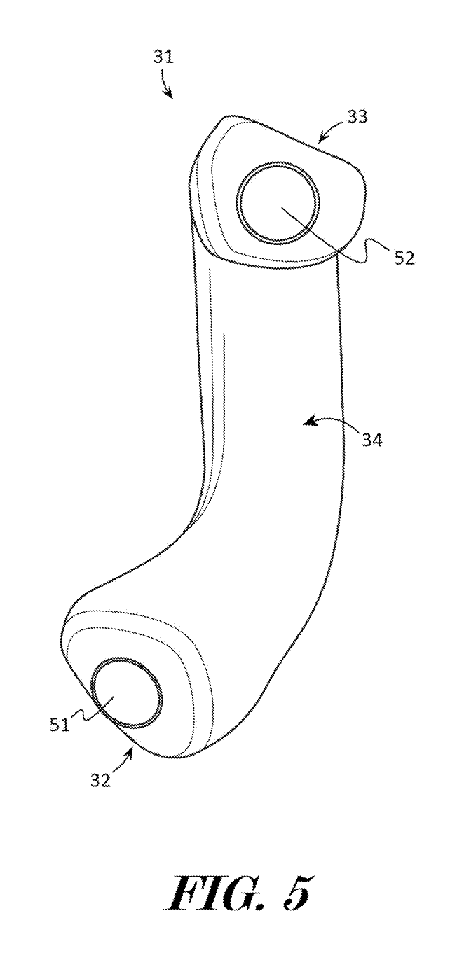

FIG. 6 shows a front perspective view of an example of an autopilot enabling device secured to a steering wheel according to various embodiments described herein.

FIG. 7 depicts a sectional, through line A-A shown in FIG. 6, side elevation view of an example of an autopilot enabling device secured to a steering wheel according to various embodiments described herein.

FIG. 8 illustrates a first side perspective view of an alternative example of an autopilot enabling device according to various embodiments described herein.

FIG. 9 shows a sectional, through line A-A shown in FIG. 6, side elevation view of an alternative example of an autopilot enabling device secured to a steering wheel according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

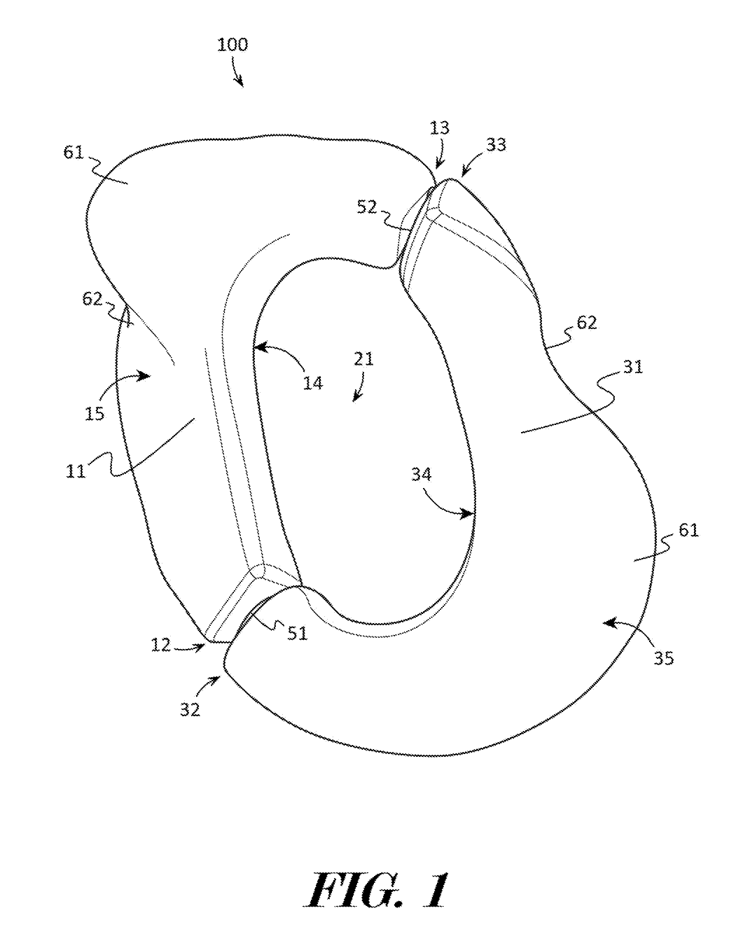

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new device which is configured to increase the duration that an autopilot or autosteer function of a vehicle may operate is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

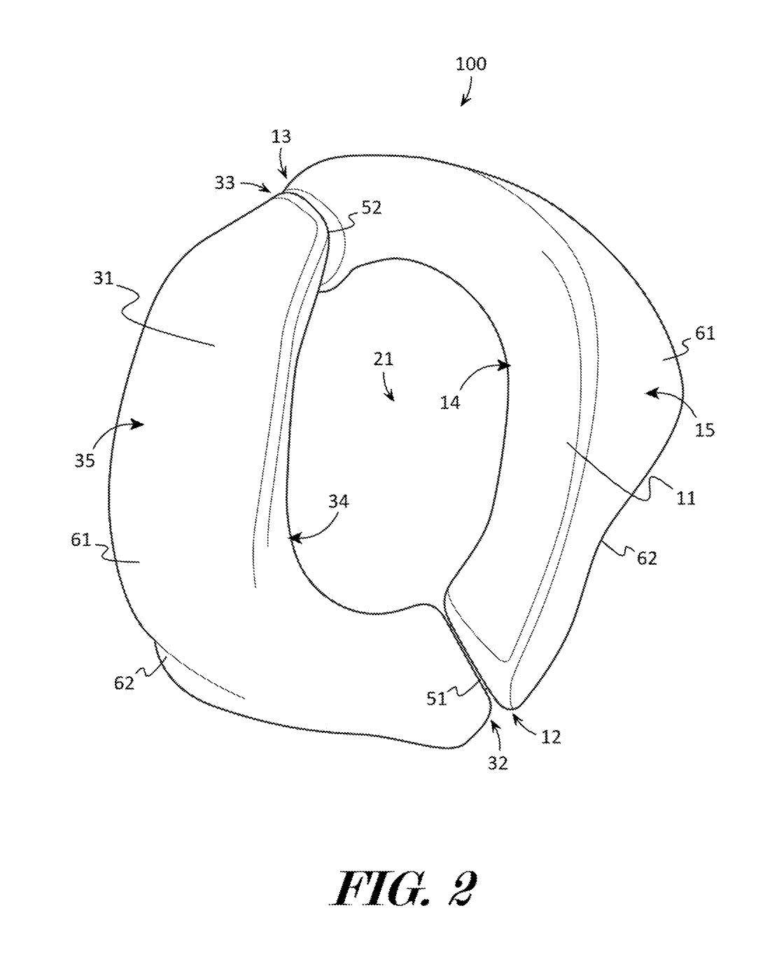

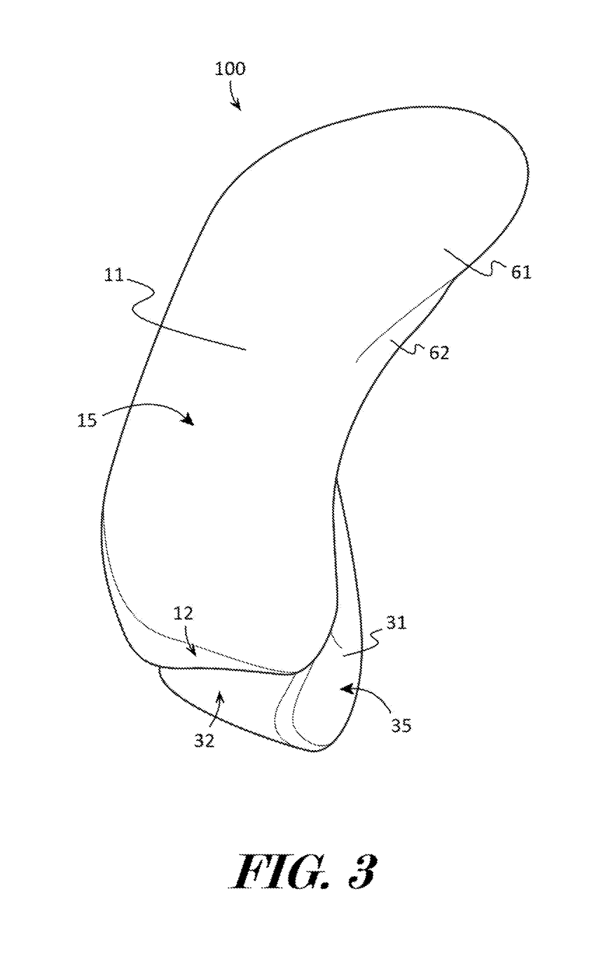

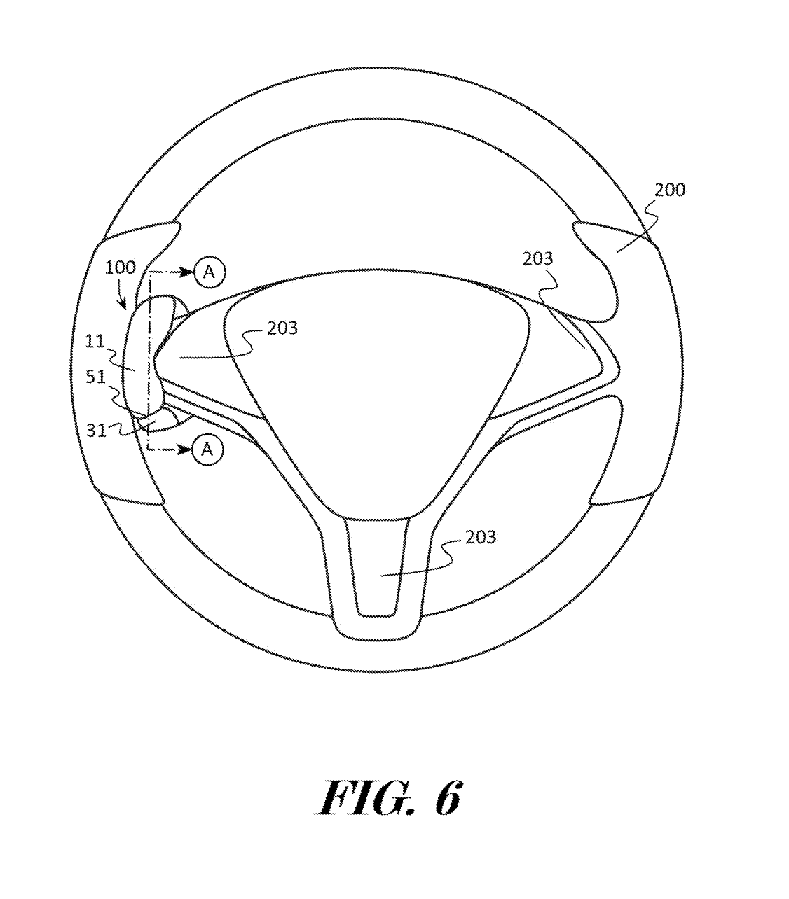

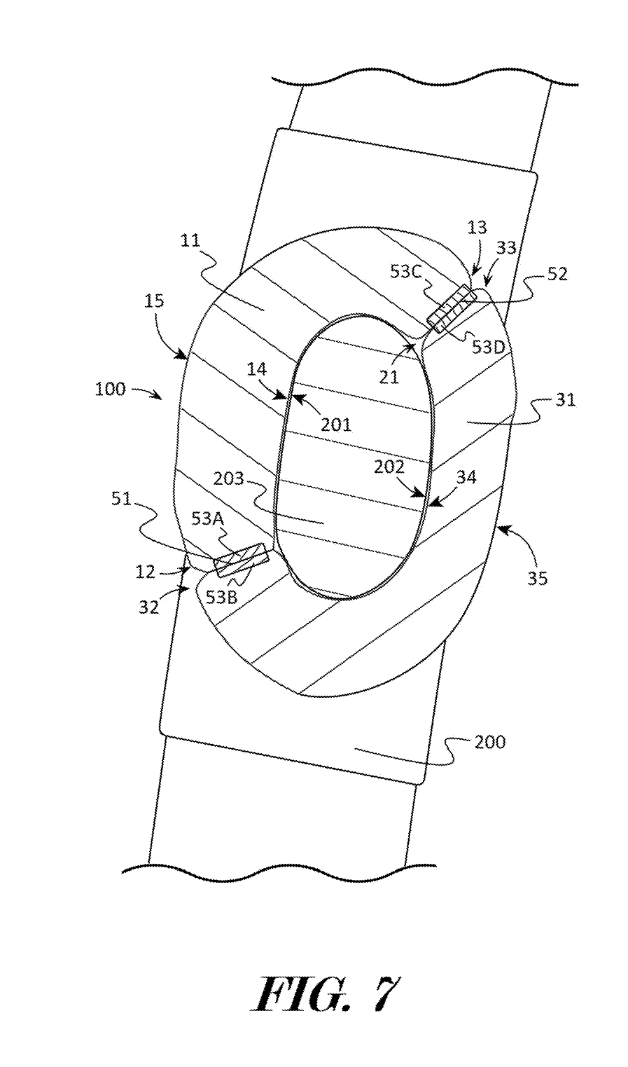

The present invention will now be described by example and through referencing the appended figures representing preferred and alternative embodiments. FIGS. 1-3 and 6-9 illustrate examples of an autopilot enabling device (“the device”) 100 according to various embodiments. Preferably, the device 100 may be configured to be coupled to portions of a steering wheel 200 of a vehicle, such as a car, truck, van, bus, boat, or airplane. In some embodiments, the device 100 may comprise an alpha subunit 11 and a beta subunit 31. The alpha subunit 11 may include a first end 12, a second end 13, and an alpha contact surface 14. The beta subunit 31 may include a first end 32, a second end 33, and a beta contact surface 34. A first coupling 51 may be configured to couple the first end 12 of the alpha subunit 11 to the first end 32 of the beta subunit 31. Optionally, a second coupling 52 may be configured to couple the second end 13 of the alpha subunit 11 to the second end 33 of the beta subunit 31. The device 100 may be secured to the steering wheel 200 by placing the alpha contact surface 14 in contact with a first portion 201 of the steering wheel 200, by placing the beta contact surface 34 in contact with a second portion 202 of the steering wheel 200, by coupling the first end 12 of the alpha subunit 11 to the first end 32 of the beta subunit 31, and by coupling the second end 13 of the alpha subunit 11 to the second end 33 of the beta subunit 31. The weight of the device 100 on the steering wheel 200 may be interpreted as user interaction by the autopilot or autosteer feature of the vehicle thereby preventing the autopilot or autosteer feature the vehicle from automatically disengaging or from automatically being turned off.

The device 100 may comprise one or more subunits 11, 31, which may be coupled together and which may be configured to secure or couple the device 100 to portions of a steering wheel 200. In preferred embodiments, the device 100 may comprise an alpha subunit 11 and a beta subunit 31 which may be coupled together and which may be configured to secure or couple the device 100 to portions of a steering wheel 200 by gripping portions of the steering wheel 200. In alternative embodiments, the device 100 may comprise an alpha subunit 11 and a beta subunit 31 which may be integrally formed together or otherwise coupled together in a non-removable manner so that the device 100 may be monolithic in design. In further alternative embodiments, the device 100 may comprise three or more subunits 11, 31, which may be coupled together and which may be configured to secure or couple the device 100 to portions of a steering wheel 200.

In some embodiments, the device 100 may comprise an alpha subunit 11 which may be configured to contact one or more portions of a steering wheel 200. An alpha subunit 11 may include one or more alpha contact surfaces 14 which may form the portions of the alpha subunit 11 which may contact the one or more portions of a steering wheel 200. An alpha subunit 11 may further include a first end 12 and a second end 13 which may be opposingly positioned to each other. An exterior surface 15 may extend between the first end 12 and second end 13 which may form a surface suitable for contacting portions of the hand of a user, such as when the user may turn, hold, or otherwise interact with a steering wheel 200 to which the device 100 is secured. One or more alpha contact surfaces 14 may be opposingly positioned to the exterior surface 15 anywhere between the first end 12 and second end 13. In preferred embodiments, an alpha contact surface 14 may be configured to contact one or more front or driver facing portions of the steering wheel 200. In further embodiments, an alpha contact surface 14 may be configured to contact one or more upper, lower, and/or rear portions of the steering wheel 200.

In some embodiments, the device 100 may comprise a beta subunit 31 which may be configured to contact one or more portions of a steering wheel 200. A beta subunit 31 may include one or more beta contact surfaces 34 which may form the portions of the beta subunit 31 which may contact the one or more portions of a steering wheel 200. A beta subunit 31 may further include a first end 32 and a second end 33 which may be opposingly positioned to each other. An exterior surface 35 may extend between the first end 32 and second end 33 which may form a surface suitable for contacting portions of the hand of a user, such as when the user may turn, hold, or otherwise interact with a steering wheel 200 to which the device 100 is secured. One or more beta contact surfaces 34 may be opposingly positioned to the exterior surface 35 anywhere between the first end 32 and second end 33. In preferred embodiments, a beta contact surface 34 may be configured to contact one or more rear portions of the steering wheel 200. In further embodiments, a beta contact surface 34 may be configured to contact one or more upper, lower, and/or front or driver facing portions of the steering wheel 200.

The alpha subunit 11 and beta subunit 31, including their respective contact surfaces 14, 34, and exterior surfaces 15, 35, may be made from or may comprise any material which may be suitable for contact with a steering wheel 200 and a hand of a user. In some embodiments, the alpha subunit 11 and beta subunit 31, including their respective contact surfaces 14, 34, and exterior surfaces 15, 35, may be made from or may comprise steel alloys, aluminum, aluminum alloys, copper alloys, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid. In further embodiments, the alpha subunit 11 and beta subunit 31, including their respective contact surfaces 14, 34, and exterior surfaces 15, 35, may be made from or may comprise a flexible or resilient material such as silicone foam, silicone rubber, rubber foam, urethane foam, plastic foam, neoprene foam, latex foam rubber, polyurethane foam rubber, or elastomer materials such as elastic plastic, elastic silicone, elastic rubber, or any other suitable elastomer or resilient material including combinations of materials.

In some embodiments, the device 100 may comprise one or more protrusions 61 which may be positioned on an alpha subunit 11 and/or on a beta subunit 31. Generally, a protrusion 61 may be disposed on an exterior surface 15, 35, and may generally extend above other portions of an exterior surface 15, 35, and/or above a depression 62. A protrusion 61 may be configured in any size and shape. Preferably, a protrusion 61 may be configured with a convex bulbous or convex rounded shape which may be suitable for contact with one or more figures of a user which may interact with a steering wheel having the device 100 secured thereto.

In some embodiments, the device 100 may comprise one or more depressions 62 which may be positioned on an alpha subunit 11 and/or on a beta subunit 31. Generally, a depression 62 may be disposed on an exterior surface 15, 35, and may generally extend above other portions of an exterior surface 15, 35, and/or below a protrusion 62. A depression 62 may be configured in any size and shape. Preferably, a depression 62 may be configured with a concave bulbous or concave rounded shape which may be suitable for contact with one or more figures of a user which may interact with a steering wheel having the device 100 secured thereto.

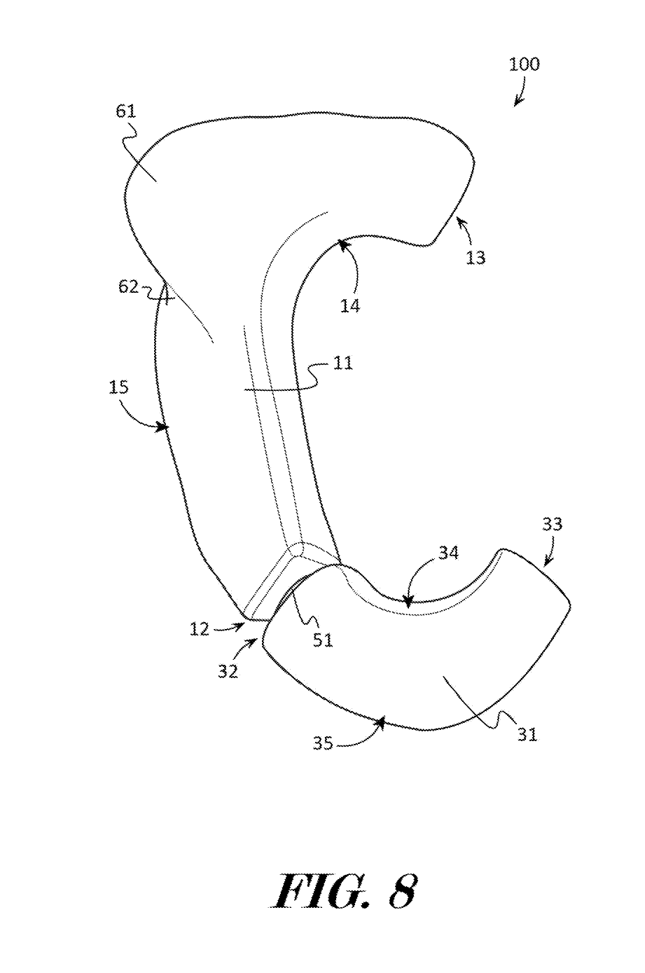

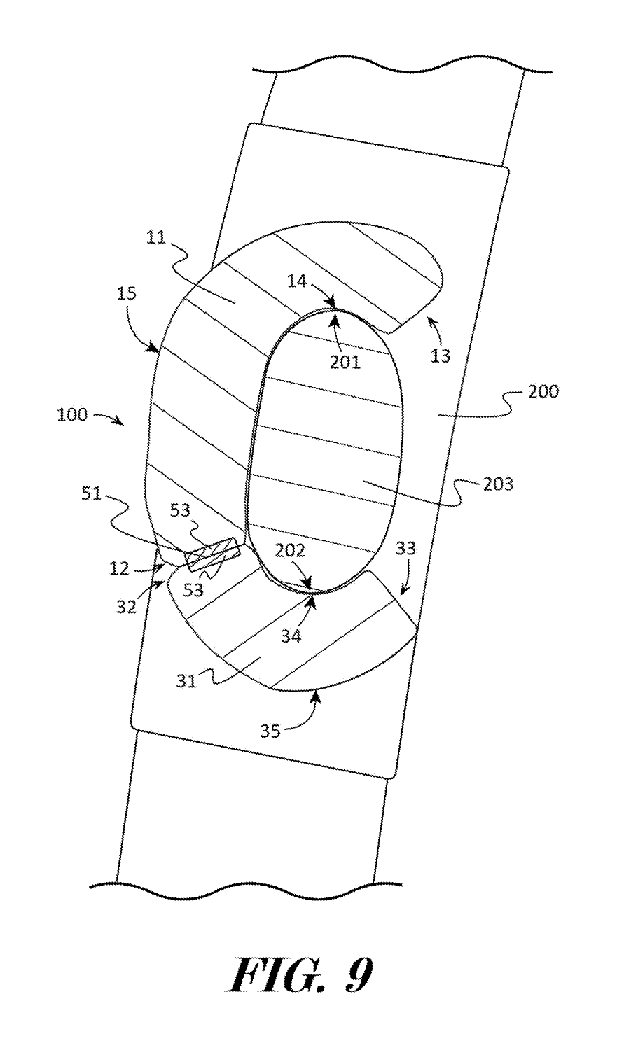

The device 100 may comprise one or more couplings 51, 52, which may be configured to couple an alpha subunit 11 to a beta subunit 31. In some embodiments and as shown in FIGS. 8 and 9, the device 100 may comprise a first coupling 51 which may couple the first end 12 of the alpha subunit 11 to the first end 32 of the beta subunit 31. In further embodiments, the device 100 may comprise a first coupling 51 which may couple the first end 12 of the alpha subunit 11 to the first end 32 of the beta subunit 31 and a second coupling 52 which may couple the second end 13 of the alpha subunit 11 to the second end 33 of the beta subunit 31. In alternative embodiments, the device 100 may comprise three or more couplings 51, 52, which be used to couple three or more subunits 11, 31, together.

In some embodiments, a coupling 51, 52, may be configured as a magnetic coupling which may be configured to removably and magnetically couple a subunit 11, 31, to another subunit 11, 31. A coupling 51, 52, configured as a magnetic coupling may comprise one or more magnetic materials 53 which may be magnetically attracted to each other. A magnetic material 53 may be or may comprise a high-coercivity ferromagnetic compound type of magnetic material such as ferric oxide mixed with a plastic binder. In other embodiments, a first fastener 31 and second fastener 32 may be or comprise a magnetic material such as ferrite, manganese-zinc ferrite, nickel-zinc ferrite, strontium ferrite, cobalt ferrite, barium ferrite, magnetic alloys such as alnico, comol, Hypernom® magnetic alloy, manganese-zinc ferrite, iron-silicon magnet alloys, nickel-zinc ferrite, ferritic stainless steel alloys, strontium ferrite, barium ferrite, alnico, iron-silicon magnet alloy, Chromindur® (Chromium-Cobalt-Iron) alloys, Silmanal (Silver-Manganese-Aluminium) alloys, Platinax II (platinum-cobalt) alloy, Bismanol (manganese bismuthide) alloy, cobalt-platinum alloys, chromium-manganese antimonide alloy, vectolite (cobalt ferrite), magnadur (sintered barium ferrite), lodex (oxide-coated iron-cobalt particles), awaruite (Ni2Fe to Ni3Fe nickel-iron alloy), wairauite, rare earth magnets such as samarium-cobalt, cesium-cobalt, neodymium-iron-boron, other neodymium magnet materials, metallic oxides such as magnetite, ulvospinel, hematite, ilmenite, maghemite, jacobsite, iron sulfides such as pyrrhotite, greigite, troilite, metallic oxyhydroxides such as goethite, lepidocrocite, feroxyhyte, ferrimagnetic materials such as magnetite, pyrrhotite, cubic ferrites, hexagonal ferrites, ferromagnetic materials including metals such as iron, nickel, cobalt, metal alloys containing iron, nickel, and/or cobalt, soft magnetic materials, hard magnetic materials, or any other suitable magnetic material, that is capable of magnetically adhering to another magnetic material through the principle of magnetism.

In some embodiments, a first coupling 51 may comprise a first magnetic material 53A which may be disposed in the first end 12 of the alpha subunit 11 and a second magnetic material 53B which may be disposed in the first end 32 of the beta subunit 31. When the first end 12 of the alpha subunit 11 is positioned proximate to or in contact with the first end 32 of the beta subunit 31, the magnetic materials 53A, 53B, of the first coupling 51 may be attracted to each other to couple the first ends 12, 32, together. In further embodiments, a second coupling 52 may comprise a third magnetic material 53C which may be disposed in the second end 13 of the alpha subunit 11 and a fourth magnetic material 53D which may be disposed in the second end 33 of the beta subunit 31. When the second end 13 of the alpha subunit 11 is positioned proximate to or in contact with the second end 33 of the beta subunit 31, the magnetic materials 53C, 53D, of the second coupling 52 may be attracted to each other to couple the second ends 13, 33, together.

In other embodiments, a first coupling 51 and/or a second coupling 52 may be configured as a removable coupling. A removably coupling may include a hook and loop type or Velcro® fastener, threaded type fastener, such as a screw, bolt, and the like, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method which may be used to removably couple portions of a first coupling 51 to a second coupling 52.

In alternative embodiments, a first coupling 51 and/or a second coupling 52 may be configured as a generally non-removable coupling. A generally non-removable coupling may include heat welding or heat bonding, being integrally molded or formed together, generally non-removable adhesives such as Cyanoacrylates and epoxies, rivets, a generally non-removable push-to-lock type connection method, or any other generally non-removable coupling method which may be used to couple portions of a first coupling 51 to a second coupling 52 in a generally non-removable manner.

The device 100 may be configured in any size and weight. In some embodiments, the device 100 may be configured with a weight that is approximately between 2 and 40 ounces. In further embodiments, the device 100 may be configured with a weight that is approximately between 8 and 36 ounces. In still further embodiments, the device 100 may be configured with a weight that is approximately between 10 and 14 ounces.

As perhaps best shown in FIGS. 1, 2, 7, 8, and 9, in preferred embodiments, portions of the alpha contact surface 14 and portions of the beta contact surface 34 may be positioned opposite to each other when the first end 12 of the alpha subunit 11 is coupled to the first end 32 of the beta subunit 31. As shown in FIGS. FIGS. 1, 2, and 7, in further embodiments, portions of the alpha contact surface 14 and portions of the beta contact surface 34 may be positioned opposite to each other when the first end 12 of the alpha subunit 11 is coupled to the first end 32 of the beta subunit 31 and when the second end 13 of the alpha subunit 11 is coupled to the second end 33 of the beta subunit 31. When the device 100 is secured or coupled to a steering wheel 200, a first portion 201 of the steering wheel 200 and an opposing second portion 202 of the steering wheel 200 may be contacted or gripped between the opposing alpha contact surface 14 and beta contact surface 34. It should be noted that a first portion 201 and second portion 202 may be located anywhere on the steering wheel 200 so that the first portion 201 and second portion 201 may be on a singular element of the steering wheel 200 and may be located on generally opposing sides of the element of the steering wheel 200.

In preferred embodiments, the device 100 may be secured or coupled to a support arm 203 of a steering wheel 200 in which a support arm 203 may radiate out between the inner regions and outer regions of the steering wheel 200 so that when the device 100 is secured or coupled to a support arm 203, a first portion 201 of the support arm 203 and an opposing second portion 202 of the support arm 203 may be contacted or gripped between the opposing alpha contact surface 14 and beta contact surface 34. In alternative embodiments, the device 100 may be coupled or secured to any portion of the steering wheel 200 so that when the device 100 is secured or coupled to a steering wheel 200, a first portion 201 of the steering wheel 200 and an opposing second portion 202 of the steering wheel 200 may be contacted or gripped between the opposing alpha contact surface 14 and beta contact surface 34.

Referring now to FIGS. 1, 2, and 7, in some embodiments, the device 100 may comprise a wheel aperture 21. A wheel aperture 21 may comprise an opening or aperture which may generally encircle portions of a steering wheel 200. A wheel aperture 21 may be configured in any shape or size which may enable portions of a steering wheel 200 of any shape and size to be received in or inserted through the wheel aperture 21. Preferably, a wheel aperture 21 may be complementary in shape and slightly larger than portions of a steering wheel 200 which are to be positioned with in the wheel aperture 21 so that the device 100 may be frictionally retained in position on a desired portion of a steering wheel 200. In some embodiments, a wheel aperture 21 may be formed between the alpha subunit 11 and beta subunit 31 when the first end 12 of the alpha subunit 11 is coupled to the first end 32 of the beta subunit 31 and when the second end 13 of the alpha subunit 11 is coupled to the second end 3 of the beta subunit 31. In preferred embodiments, an alpha contact surface 14 and a beta contact surface 34 may each form at least a portion of the wheel aperture 21. In further embodiments, an alpha contact surface 14 and a beta contact surface 34 may together form the wheel aperture 21.

While some exemplary shapes and sizes have been provided for elements of the device 100, it should be understood to one of ordinary skill in the art that the alpha subunit 11, beta subunit 31, and any other element described herein may be configured in a plurality of sizes and shapes including “J” shaped, “C” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In preferred embodiments, one or more elements may be constructed from selective laser sintering (SLS) materials (e.g nylon/polyamide), direct metal laser sintering (DMLS), and/or selective laser melting (SLM) materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An autopilot enabling device for use with a vehicle having a steering wheel, the device comprising:
an alpha subunit having a first end, a second end, and an alpha contact surface;
a beta subunit having a first end, a second end, and a beta contact surface;
a first coupling configured to couple the first end of the alpha subunit to the first end of the beta subunit;
wherein the device is secured to the steering wheel by placing the alpha contact surface in contact with a first portion of the steering wheel, by placing the beta contact surface in contact with a second portion of the steering wheel, by coupling the first end of the alpha subunit to the first end of the beta subunit, and by coupling the second end of the alpha subunit to the second end of the beta subunit.

2. The device of claim 1, wherein portions of the alpha contact surface and portions of the beta contact surface are positioned opposite to each other when the first end of the alpha subunit is coupled to the first end of the beta subunit.

3. The device of claim 1, wherein the device comprises a weight between 8 ounces and 36 ounces.

4. The device of claim 1, further comprising a second coupling configured to couple the second end of the alpha subunit to the second end of the beta subunit.

5. The device of claim 5, wherein a wheel aperture is formed between the alpha subunit and beta subunit when the first end of the alpha subunit is coupled to the first end of the beta subunit and when the second end of the alpha subunit is coupled to the second end of the beta subunit.

6. The device of claim 5, wherein the alpha contact surface and beta contact surface each form at least a portion of the wheel aperture.

7. The device of claim 5, wherein a coupling selected from the group consisting essentially of the first coupling and the second coupling comprises a magnetic material.

8. The device of claim 5, wherein the second coupling is formed by a magnetic material disposed in the second end of the alpha subunit and by a magnetic material disposed in the second end of the beta subunit.

9. The device of claim 5, wherein a coupling selected from the group consisting essentially of the first coupling and the second coupling comprises a removable coupling.

10. The device of claim 1, wherein the device comprises a finger protrusion.

11. The device of claim 1, wherein the first coupling is formed by a magnetic material disposed in the first end of the alpha subunit and by a magnetic material disposed in the first end of the beta subunit.

12. An autopilot enabling device for use with a vehicle having a steering wheel having a support arm, the device comprising:
an alpha subunit having a first end, a second end, and an alpha contact surface;
a beta subunit having a first end, a second end, and a beta contact surface;
a first coupling configured to couple the first end of the alpha subunit to the first end of the beta subunit;
a second coupling configured to couple the second end of the alpha subunit to the second end of the beta subunit;
a wheel aperture formed between the alpha subunit and beta subunit when the first end of the alpha subunit is coupled to the first end of the beta subunit and when the second end of the alpha subunit is coupled to the second end of the beta subunit, wherein the alpha contact surface and beta contact surface each form at least a portion of the wheel aperture, wherein the device is secured to the steering wheel by placing portions of the support arm in the wheel aperture with the alpha contact surface in contact with a first portion of the support arm and the beta contact surface in contact with a second portion of the support arm, by coupling the first end of the alpha subunit to the first end of the beta subunit, and by coupling the second end of the alpha subunit to the second end of the beta subunit.

13. The device of claim 12, wherein portions of the alpha contact surface and portions of the beta contact surface are positioned opposite to each other when the first end of the alpha subunit is coupled to the first end of the beta subunit and when the second end of the alpha subunit is coupled to the second end of the beta subunit.

14. The device of claim 12, wherein the device comprises a weight between 8 ounces and 36 ounces.

15. The device of claim 12, wherein a coupling selected from the group consisting essentially of the first coupling and the second coupling comprises a magnetic material.

16. The device of claim 12, wherein a coupling selected from the group consisting essentially of the first coupling and the second coupling comprises a removable coupling.

17. The device of claim 12, wherein the device comprises a finger protrusion.

18. The device of claim 12, wherein the device comprises a finger depression.

19. The device of claim 12, wherein the first coupling is formed by a magnetic material disposed in the first end of the alpha subunit and by a magnetic material disposed in the first end of the beta subunit.

20. The device of claim 12, wherein the second coupling is formed by a magnetic material disposed in the second end of the alpha subunit and by a magnetic material disposed in the second end of the beta subunit.
